(19) United States
(12) Patent Application Publication
(10) Pub. No.: US 2023/0334519 A1
(43) Pub. Date: Oct. 19, 2023

(54) SYSTEM FOR OPTIMAL LOCATION AND OPERATION OF DISTRIBUTED ENERGY RESOURCES

(71) Applicant: Enovation Analytics, LLC, Colleyville, TX (US)

(72) Inventors: Charles Kitowski, Colleyville, TX (US); Zachary Kitowski, Costa Mesa, CA (US); Fred Guan, Austin, TX (US); Mansoureh Peydayesh, Houston, TX (US)

(21) Appl. No.: 18/302,742

(22) Filed: Apr. 18, 2023

Related U.S. Application Data
(60) Provisional application No. 63/363,209, filed on Apr. 19, 2022.

(51) Int. Cl. G06Q 30/0201; H02J 3/38

(52) U.S. Cl. CPC G06Q 30/0206; H02J 3/381

(57) ABSTRACT

Relevant inputs are obtained, including details of the DER and potential locations for the DER, from a user. Using that information, initial price predictions are developed. With those price predictions, an initial optimization of the location economics and operating schedule are developed for each location. Based on the optimization output, a final price prediction which includes the effects of the DERs, operating per the initial operating schedule is developed for each location. Those results are then optimized to provide the final economics and operating schedule for each location. These final optimization results are provided to the user, preferably sorted in a requested order, such as best economics.

### CROSS-REFERENCE

This application claims priority to U.S. Provisional Application Ser. No. 63/363,209, filed Apr. 19, 2022, the contents of which are incorporated herein in their entirety by reference.

### TECHNICAL FIELD

This disclosure relates generally to operation of distributed energy resources.

### BACKGROUND

The use of distributed energy resources (DERs) is becoming common. Examples of residential distributed energy resources are batteries, solar photovoltaic panels, small wind turbines, natural-gas-fired fuel cells, and emergency backup generators, usually fueled by natural gas, gas oline or diesel fuel. Examples of commercial and industrial distributed energy resources are batteries and other storage, combined heat and power systems, solar photovoltaic panels, wind, hydropower, biomass combustion or cofiring, municipal solid waste incineration, fuel cells fired by natural gas or biomass and reciprocating combustion engines, including backup generators, which may be fueled by oil. Any of these options may be used by the electrical grid operator, as well as residential, commercial or industrial third parties.

Installation and operation of any of the DERs is an expense proposition, so choice of location and operating protocols are important when options are available.

### BRIEF DESCRIPTION OF THE DRAWINGS

For illustration, there are shown in the drawings certain examples described in the present disclosure. In the drawings, like numerals indicate like elements throughout. The full scope of the inventions disclosed herein are not limited to the precise arrangements, dimensions, and instruments shown. In the drawings:

FIG. 1 is a flowchart of expense and operating behavior development according to the present invention.

FIG. 2 is an exemplary neural network according to the present invention.

FIG. 3 is a block diagram of a computer system according to the present invention.

### DETAILED DESCRIPTION

Optimal siting of a DER and operation of the DER depends on many factors: the properties of the DER itself, the electrical environment into which the DER is placed, the economic environment into which the DER is placed, and others. Further, the DER itself changes the environments once it is installed, so analysis should also take that into consideration.

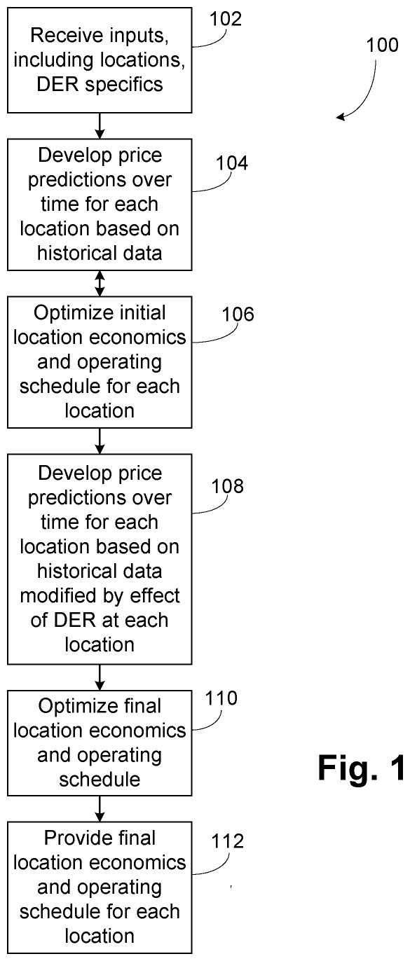

Referring to FIG. 1, in an embodiment according to the present invention, a flowchart 100 to determine location and operation of a DER is shown. In step 102, the relevant inputs are obtained, including details of the DER and potential locations for the DER, from a user. Using that information, in step 104 initial price predictions are developed. With those price predictions, in step 106 an initial optimization of the location economics and operating schedule are developed for each location. Based on the optimization output, in step 108 a final price prediction which includes the effects of the DERs, operating per the initial operating schedule is developed for each location. Those results are then optimized in step 110 to provide the final economics and operating schedule for each location. In step 112, these final optimization results are provided to the user, preferably sorted in a requested order, such as best economics.

While the above is an overall summary, provided here are details on the various steps. Besides locations at a zip code granularity, the details of the DER inputs are in different categories of DER capital and physical characteristics, operating limits and preferences, and available wholesale market revenue streams. Examples include but are not limited to:
DER construction costs
DER price and O&M cost including any escalation or degradation over the years
Detailed DER performance parameters (size, efficiency, capacity and efficiency degradation, cycle limit, lifetime, . . . )
Detailed solar/wind output data (for coupled DERs)
Market participation selection and preferences
Applicable tariffs, incentives, and policies

Historical nodal prices of electricity market products and services for each location are retrieved from a database containing those details.

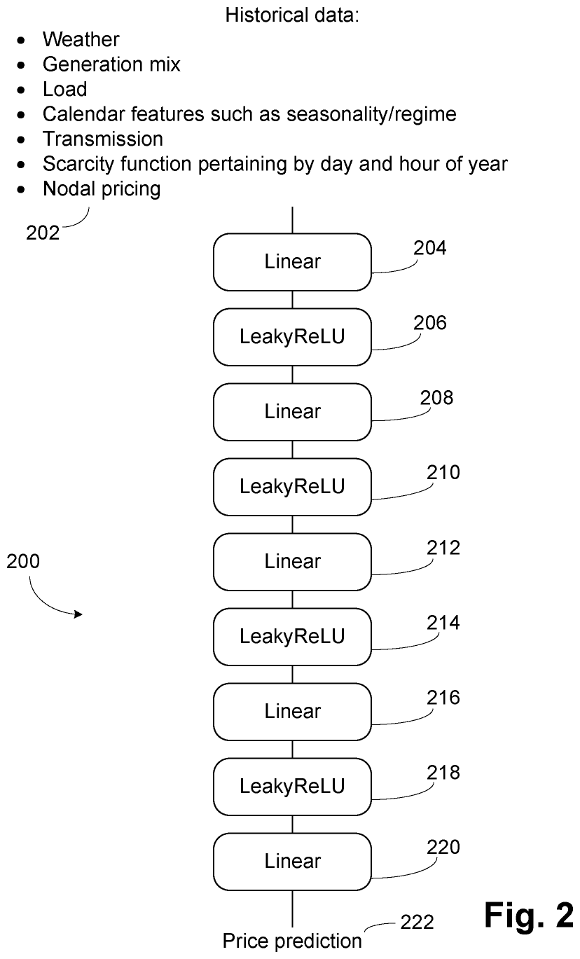

A neural network 200 as shown in FIG. 2 is used to develop the initial price predictions. The neural network 200 is trained using historical data comprising weather, generation mix, load, calendar features such as seasonality/regime, transmission and a scarcity function pertaining by day and hour of year, in conjunction with the historical nodal pricing. The scarcity function is defined by the amount of generation available for market participation combined with a reliability index for generation mix.

In one embodiment, the neural network 200 is constructed of five linear layers with four LeakyReLU (Leaky Rectified Linear Unit) layers 206, 210, 214, 218 in between them, the final linear layer 220 serving as the layer to output price prediction. The linear layers 204, 208, 212, 216, 220 utilized have respective output feature sizes of 4096, 2048, 1024, 1024, and 1 in that order. For the purposes of optimization, the AdamW optimizer is used for the training process for its ability to better generalize to unseen data than the traditional Adam optimizer regarding many datasets. Once trained, upon receiving initial projections about future generation mix, load growth and weather, obtained from various sources, the output is the initial price prediction for a desired period of time. Preferably all calculations and predictions are done using 15 minute or hourly data. In some embodiments, the price predictions for given locations are performed prior to and separate from the remainder of the processing, so that the initial pricing prediction is a database lookup, rather than real time computations.

It is understood that this is an exemplary neural network and other neural network configurations can be used after proper training.

The price prediction outputs are then fed into the optimization engine. In one embodiment, the optimization is an MILP optimization considering detailed DER performance model, operational constraints and ISO/RTO specific market rules. The objective function of this optimization problem is to maximize resulting market revenues minus operational cost of the DER. In addition to financial calculations, the optimization output provides hourly operational behavior for the decided DER.

For example, dispatching an energy storage DER is a non-linear optimization problem that the optimization operation solves using linear programming transformation techniques and Mixed Integer Linear Programming (MILP) optimization.

The optimal decision maximizes the profit while it satisfies all the physical and operational constraints. In one embodiment, one important physical characteristic of an energy storage DER is the state-of-charge (SoC) which shows how much energy is stored in the DER. If the energy storage DER participates in Energy and Ancillary Services (AS) markets, the optimization solver decides when to charge the DER from the grid, when to discharge the DER into the grid to participate in the Energy market, and when to keep the capacity and energy available to participate in the AS market. The optimization solver predicts the DER SoC after participation in the Energy and AS markets to accurately decide about the next interval dispatch while satisfying the SoC constraint.

The initial prices are predicted based on the traditional behavior of the system generation units and electricity demand. However, by increasing the penetration of the DER assets in the system, the traditional behavior will be affected. For this reason, in a separate process, future DERs penetration in the system has been assessed in terms of types, sizes, and locations. The optimization engine determines DERs behavior based on the predicted prices by optimizing their profit considering all physical and operational constraints.

The hourly dispatch profiles are then taken back to the future pricing datasets to serve as a modification to initial hourly projections about the system supply and demand. Consequently, the data features regarding generation mix and load for the future are changed impactfully at an hourly level in regards to the added DERs and their locations. This updated data is then fed through the same neural network as before, thus outputting final price predictions reflective of the DERs' impact on the grid and the market.

The final price predictions are then used as inputs to the optimization process for the specific DER. The final outputs of the optimization process are then the final economics and hourly dispatch schedule for each location and DER of interest. These outputs are then provided for review, with the dispatch schedule forming the basis for operating the DER.

After some period of operation, the price prediction process can be repeated while updating the training set of the neural network model and considering any ISO/RTO regulatory changes.

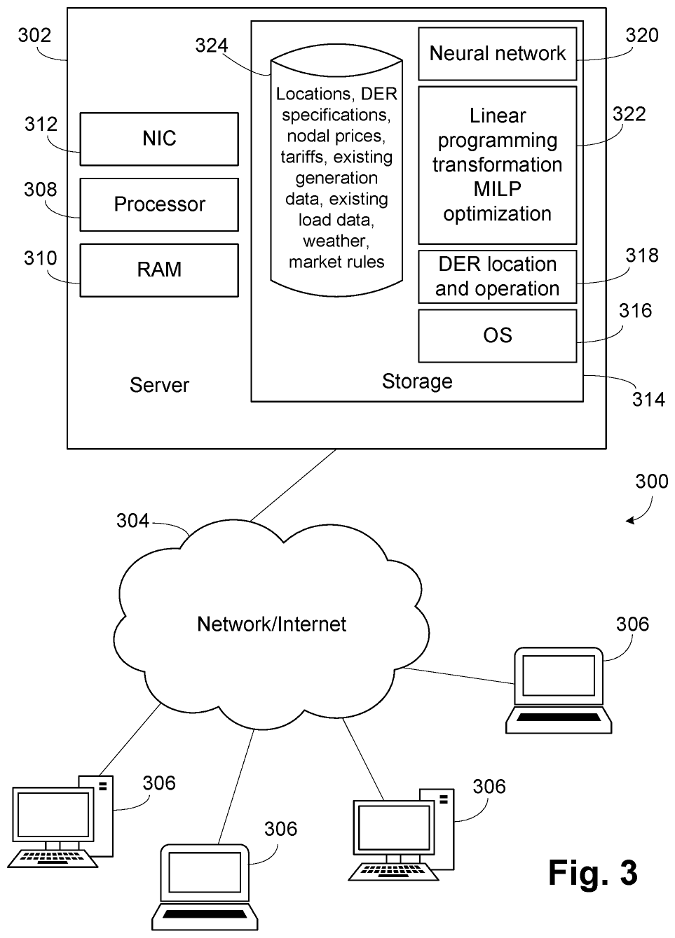

FIG. 3 illustrates an exemplary computer system for performing the operations. The system 30o includes a server 302 connected to a network and/or the Internet 304, to which various user computers 306 are connected. This allows users of the user computers 306 to provide inputs to the process and to receive results of the process.

The server 302 includes a processor 308, RAM 310 used to store programs and data during operation of the system 300, a network interface card (NIC) 312 to connect to the network 304, and non-volatile program storage 314. Programs contained in the storage 314 are an operating system 316; an overall DER location and operation program 318 which executes the flowchart 100; a neural network 320, such as the neural network 200, and linear programming transformation and MILP optimization program 322. Storage 314 further includes a database containing the data needed to operate the neural network and the optimization, including location data, DER specifications, nodal prices, tariffs, existing generation data, existing load data, weather, and market rules.

It is understood that this is a highly simplified illustration of the system, 300 and an actual system may be configured in numerous different ways to perform the operations.

By performing a second pass based on load and other changes due to the impact of the DERs, better predictions and an improved dispatch or operational schedule are obtained.

The various examples described are provided by way of illustration and should not be construed to limit the scope of the disclosure. Various modifications and changes can be made to the principles and examples described herein without departing from the scope of the disclosure and without departing from the claims which follow.

1. A method for determining placement and operating schedule of a distributed energy resource (DER), the method comprising:
obtaining relevant inputs, including details of the DER and potential locations for the DER;
using those inputs, developing initial price predictions for each location;
performing an initial optimization of the economics and DER operating schedule for each location;
integrating the DER operating schedule into the obtained relevant inputs for each location;
using the integrated inputs, developing final price predictions for each location;
performing a final optimization of the economics and DER operating schedule for each location to produce final economics and DER operating schedule for each location; and
providing the final optimization results.

2. The method of claim 1, wherein the initial and final price predictions are done for a 15 minute or hourly basis and the operating schedule is produced for an hourly schedule.

3. The method of claim 1, wherein the initial and final price predictions are performed using a neural network.

4. The method of claim 1, wherein the optimization is an MILP optimization.

5. The method of claim 1, further comprising:
operating the DER according to the final DER operating schedule.

6. A computer system for determining placement and operating schedule of a distributed energy resource (DER), the computer system comprising:
a processor;
memory coupled to the processor for storing programs and data;
non-volatile storage for storing programs executed by the processor, the programs including programs to cause the processor to:
obtain relevant inputs, including details of the DER and potential locations for the DER;
using those inputs, develop initial price predictions for each location;
perform an initial optimization of the economics and DER operating schedule for each location;
integrate the DER operating schedule into the obtained relevant inputs for each location;
using the integrated inputs, develop final price predictions for each location;
perform a final optimization of the economics and DER operating schedule for each location to produce final economics and DER operating schedule for each location; and
provide the final optimization results.

7. The computer system of claim 6, wherein the initial and final price predictions are done for a 15 minute or hourly basis and the operating schedule is produced for an hourly schedule.

8. The computer system of claim 6, wherein programs include a neural network to develop the initial and final price predictions.

9. The computer system of claim 6, wherein the optimization is an MILP optimization.

10. The computer system of claim 6, the programs further causing the processor to:
operate the DER according to the final DER operating schedule.

11. A non-transitory program storage device or devices, readable by one or more processors and comprising instructions stored thereon to cause the one or more processors to perform a method for determining placement and operating schedule of a distributed energy resource (DER), the method comprising:
obtaining relevant inputs, including details of the DER and potential locations for the DER;
using those inputs, developing initial price predictions for each location;
performing an initial optimization of the economics and DER operating schedule for each location;
integrating the DER operating schedule into the obtained relevant inputs for each location;
using the integrated inputs, developing final price predictions for each location;
performing a final optimization of the economics and DER operating schedule for each location to produce final economics and DER operating schedule for each location; and
providing the final optimization results.

12. The non-transitory program storage device or devices of claim 11, wherein the initial and final price predictions are done for a 15 minute or hourly basis and the operating schedule is produced for an hourly schedule.

13. The non-transitory program storage device or devices of claim 11, wherein the initial and final price predictions are performed using a neural network.

14. The non-transitory program storage device or devices of claim 11, wherein the optimization is an MILP optimization.

15. The non-transitory program storage device or devices of claim 11, the method further comprising:
operating the DER according to the final DER operating schedule.
